(19) United States
(12) Patent Application Publication
(10) Pub. No.: US 2015/0346943 A1
(43) Pub. Date: Dec. 3, 2015

(54) STORAGE DEVICE FOR TOUCH SCREEN DISPLAYS

(71) Applicants: Vidya Srinivas, Bangalore (IN); Srinath Duraisamy, Bangalore (IN)

(72) Inventors: Vidya Srinivas, Bangalore (IN); Srinath Duraisamy, Bangalore (IN)

(21) Appl. No.: 14/293,800

(22) Filed: Jun. 2, 2014

(51) Int. Cl. G06F 3/0488; G06F 3/0484; G06F 3/0482; H04W 4/00

(52) U.S. Cl. CPC G06F 3/0488; H04W 4/008; G06F 3/04842; G06F 3/0482

(57) ABSTRACT

A touch-based storage device configured for wireless transfer of data between the touch-based storage device and touch-enable electronic devices having touchscreen displays. The touch-based storage device may operationally interface with a touch sensor of the electronic device upon or in response to wireless detection by the electronic device and contact of a touchscreen display of the electronic device. The touch-based storage device may include a wireless communication component and a memory. The touch-enabled electronic device having a processor may be configured with executable code to interact with the touch-based storage device.

### TECHNICAL FIELD

The present techniques relate generally to data storage devices and to electronic devices having touchscreen displays. More particularly, but not exclusively, the present techniques relate to touch-based storage devices for management and transfer of data between electronic devices having touchscreen displays.

### BACKGROUND

Data transfer between electronic devices generally occurs via a wired or wireless connection between the electronic devices, either directly or through an intermediate computing device. Of particular interest may be data transfer between electronic devices (e.g., personal desktop computers, laptop computers, etc.) having touchscreen displays, including between mobile electronic devices (e.g., smartphones, tablets, etc.) having touchscreen displays. Indeed, the proliferation and technology advances of such handheld electronic devices present challenges and opportunities with the management, storage, and transfer of data with and between these devices.

Unfortunately, the transfer of data may not always be readily implemented with and between such existing electronic devices (e.g., handheld or mobile devices such as smartphones, tablets, etc.) due to interface and programming considerations. Further, existing storage devices generally may have formats and interfaces typical for laptop and personal desktop computing devices, such as peripheral component interconnect (PCI) based storage, universal serial bus (USB) based storage, and serial advanced technology attachment (SATA) based storage. These formats of storage devices may not be conducive with certain mobile or handheld electronic devices.

Typically, data transfer between electronic devices including between mobile or handheld devices (e.g., smartphones, tablets, etc.) may via a wireless connection such as Bluetooth®. For Bluetooth®, the handheld devices must generally be near one another to accommodate the distance limitation (e.g., less than 100 meters) of Bluetooth®. In an alternative, the handheld devices may be on the same wireless network which typically also has proximate distance requirements. The data transfer may also occur between handheld devices connected via a cable such as USB One-the-Go (OTG) cable, or via an intermediate computing device such as through a desktop or personal computer (PC) or laptop.

### BRIEF DESCRIPTION OF DRAWINGS

FIG. 1 is representation of an exemplary touch-based storage device in accordance with embodiments of the present techniques.

FIG. 2 is representation of an exemplary touch-based storage device contacting a touchscreen display of an electronic device in accordance with embodiments of the present techniques.

FIG. 3 is a block diagram of exemplary components of an example storage device in accordance with embodiments of the present techniques.

FIG. 4 is a diagrammatical representation of an exemplary data management menu in accordance with embodiments of the present techniques.

FIG. 5 is a block flow diagram of an exemplary method 500 of operation of a touch-based storage device in accordance with embodiments of the present techniques.

FIG. 6 is a block flow diagram of an exemplary method 500 of operating a touch-based storage device in accordance with embodiments of the present techniques.

FIG. 7 is a block diagram of an example tangible, non-transitory computer-readable medium to implement embodiments of the present techniques.

FIG. 8 is a block diagram of exemplary components of an example electronic device configured to operate with a touch-based storage device in accordance with embodiments of the present techniques.

### DETAILED DESCRIPTION

Embodiments of the present techniques relate to storage devices that are touch-based, and that interface with touchscreen displays of electronic devices. The storage devices may utilize the touchscreens of the electronic devices to facilitate data transfer between the electronic devices. The touch-based storage devices may generally be employed with the large percentage of mobile or handheld electronic devices (e.g., smartphones, tablets, etc.) that are touch-enabled, and are generally applicable to any electronic device having a touchscreen display.

In examples, these touch-based storage devices may be utilized to initiate and perform a data transfer between two touch-enabled electronic devices. Such touch-enabled electronic devices generally have touchscreens and may be mobile or handheld touch-enabled electronic devices, as well as stationary touch-enabled electronic devices. The data transfer may be a remote transfer in that the touch-based storage device can be carried or transported from a first location to a second location in the transfer of data from a first electronic device to a second electronic device. The data transfer via the touch-based storage device can be between electronic devices situated on different continents, or situated in the same room, and so on.

In certain embodiments, these storage devices which are uniquely touch-based may be relatively small and/or lightweight to facilitate the possession and physical transfer of the storage devices between geographical locations. In examples, the touch-based storage device may be labeled a “nano” storage device, for instance, in that the storage device may be relatively small and easy for a person to carry or handle.

Embodiments of the touch-based storage devices may fit comfortably and ergonomically in the user's hand to promote ease of use of the storage device with the touch-enabled electronic devices. In particular examples, the storage device when employed by the user may rest against (or on) the user's finger. In certain embodiments, the touch-based storage device may resemble a thimble in shape to match with or fit on a finger. If so, the storage device may be labeled as a “TouchThimble,” for instance. Of course, other shapes and geometries (and names) of the touch-based storage devices are applicable.

In operation, for the storage device to be detected by the electronic device, the user may hold the storage device with their hand, for example, and contact the storage device to the touch-enabled screen of the electronic device. The electronic device may wirelessly detect the storage device and thus recognize the storage device as more than a mere finger or conventional stylus, for example, but as a touch storage device. Then, with the storage device wirelessly detected by the electronic device, the contact of the touch screen display (by the storage device, other object, or finger) may prompt a menu to appear and/or specify a position on the display of the data source (or destination for receipt), and the like. Thus, as discussed below, the storage device is configured to operationally interface with the electronic device via a combination of wireless and touch interfaces.

As the user brings the storage device into proximity of the electronic device, the electronic device wirelessly detects the storage device. As the user works the storage device in contact with and across the electronic device touchscreen, the electronic device may also touch sense the contact point or contact area on its touchscreen as the position of the storage device. Again, the storage device is a touch-based storage device and, thus, may operate in conjunction with a touch sensor of electronic or computing devices contemporaneous with or after the storage device is wirelessly detected.

In general, a touch-based storage device may be a storage device that operationally interfaces with a wireless component of a touch-enabled electronic (e.g., computing) device and with a touch sensor associated with a touchscreen display of the touch-enabled electronic device. Again, the wireless detection by the electronic device of the storage device may occur when the storage device is in proximity to the electronic device, and a position detection occurs when the storage device (or other object or finger) comes in contact with a touch-enabled display of the electronic or computing device. As mentioned, the wireless communication may facilitate the electronic device to recognize the storage device as more than a finger or conventional stylus, for example. The touch-based storage device, upon detection, may be configured to be a source storage or a destination storage, including in an “on-the-go” manner.

As a last introductory remark, it should be noted that while the discussion herein may focus at times on contacting the storage device to the touchscreen display of an electronic device, the storage device in certain examples need not itself contact the touchscreen display in embodiments. In other words, after the electronic device recognizes the storage device, the electronic device can then expect the next touch to its touchscreen display to be related to the storage device, and that touch may be via a finger or any object generally, including the storage device, a stylus, and the like. That touch or contact of the touchscreen display may then prompt a menu to appear on the touchscreen display in certain embodiments. Further, the point or area of the touch or contact may denote the coordinates of the touchscreen display of interest.

In on example, the storage device is a thimble-like shape and used to contact the touchscreen display after being wirelessly detected by the electronic device. In another example, the storage device is a relatively small object of any shape that may fit into the palm of a user's hand, for instance. In such an example, the user may hold the storage device in proximity to the electronic device such that storage device is wirelessly detected by the electronic device. Then, the user may touch the touchscreen with their finger, for instance, to further operation of the electronic device such as with the finger touch to the touchscreen display prompting a menu to appear on the touchscreen display, or to activate an automatic data transfer, and so on.

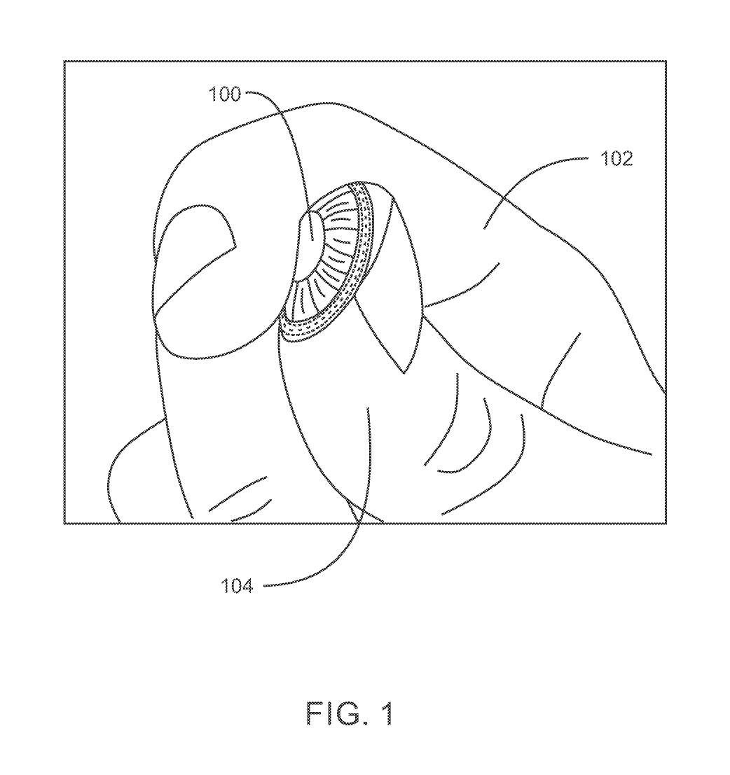

FIG. 1 is an exemplary touch-based storage device 100 held by a user, resting between the forefinger and thumb of the user's hand 102. In the illustrated embodiment, the storage device 100 is relatively thin and is concave in shape, with the concave surface fitting or resting on a tip portion the user's thumb 104. Of course, the storage device can be flipped or inverted (rotated) 180 degrees, and the concave surface of the storage device 100 fit or rest on a tip portion of the forefinger (or another finger).

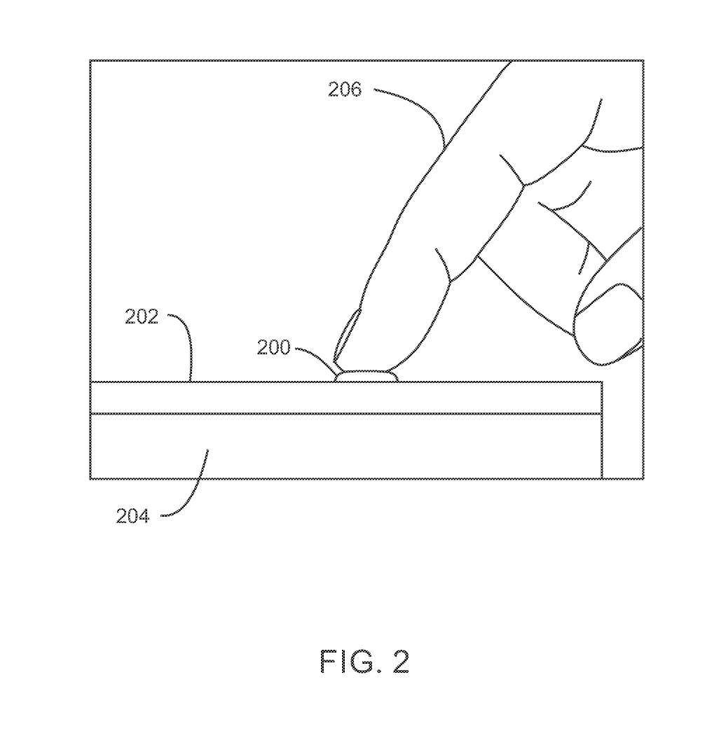

FIG. 2 is an exemplary touch-based storage device 200 placed on a surface of a touchscreen display 202 of an electronic device 204. In operation of the storage device 200, a user's finger 206 positions the concave surface of the storage device 200 facing the touchscreen display 202. Instead or in addition, the storage device 200 may be configured to operate with its concave surface facing away from the touchscreen display 202. The touch-based storage device 200 may operate in conjunction with a wireless communication component of the electronic device 204 and with a touch sensor associated with the touchscreen display 202 of the electronic device 204 (e.g., computing device).

The storage device 200 may be of different sizes and shapes, including having a stylus or pen-shape, a cube shape with a surface, for example, or other geometries. Moreover, the storage device 200 may be held or positioned with more than one finger of the user's hand in operation, and so on. As for the electronic device 204, it may be a tablet, portable all-in-one (pAIO) computing device, or smartphone, and so forth. In alternate examples, the electronic device 204 may be a laptop or desktop personal computer, an all-in-one (AIO) computing device, and the like.

The storage device 200 may be designed to fit on the fingertip which may provide ease of use or convenience. In an embodiment, the storage device 200 is configured to stick or adhere to the touchscreen display 202, which may help in cases of relatively large data transfers taking longer amounts of time, for example. This temporary adherence of the storage device 200 to the touchscreen 202 may avoid a user having to hold the device on their fingertip placed on the screen continuously (i.e., during the data transfer).

As for communication between the devices, the storage device 200 may be capable of wireless communication such as Near Field Communication (NFC) or Bluetooth®, and so on. The storage device 200 may be a passive device similar to an NFC tag. On the other hand, storage device 200 may be a Bluetooth® device, for instance. In certain examples, the storage device 200 when placed on the touch-enabled screen 202 of the electronic device 204 is detected via NFC or Bluetooth® (or via other wireless standard) by the electronic device 204 system as a storage apparatus. Again, the electronic device 204 may be a computing device such as the personal computer, laptop, handheld devices, etc. While the techniques are not limited to a particular standard or version of a standard, the latest standards of NFC and Bluetooth® may be applicable.

Bluetooth® is a wireless technology standard for exchanging data over relatively short distances generally using short-wavelength microwave from fixed and mobile devices, creating personal area networks (PANs). Bluetooth® is managed by the Bluetooth® Special Interest Group (SIG), which has more than 19,000 member companies in the areas of telecommunication, computing, networking, and consumer electronics. Bluetooth® was standardized as Institute of Electrical and Electronics Engineers (IEEE) standard IEEE 802.15.1, but the standard is no longer maintained. The SIG oversees the development of Bluetooth® specifications and qualification programs. To be marketed as a Bluetooth® device, the device must be qualified to standards defined by the SIG. Currently, the latest Bluetooth® Core Specification is version 4.1, published Dec. 3, 2013.

NFC is generally an open platform technology standardized in International Organization for Standardization/International Electrotechnical Commission (ISO/IEC) standards ISO/IEC 18092 (2nd edition published on Mar. 15, 2013) and ISO/IEC 21481 (2nd edition published on Jul. 1, 2012). These standards are generally reproduced, respectively, in European Computer Manufacturer Association (ECMA or Ecma International) standards EMCA-340 (3rd edition published June, 2013) and EMCA-352 (3rd edition published June, 2013). NFC incorporates additional standards and protocols. In general, NFC is a set of short-range wireless technologies, typically requiring a distance of 10 centimeters (cm) or less. NFC may operate at 13.56 megahertz (MHz) on ISO/IEC 18000-3 air interface. In certain examples, NFC may involve an initiator and a target, and with the initiator generating an RF field that can power a passive target.

In certain embodiments, a NFC antenna (e.g., a “nano” NFC antenna) or Bluetooth® capability may be built-in the storage device 200. The NFC antenna may typically be relatively small. In fact, the NFC “antenna” may be similar to an inductor (e.g., loops of wire) occupying surface area of the storage device 200. The NFC antenna or Bluetooth® capability may generally be embedded within the storage device 200, so as not to significantly physically interfere with the touch area. Lastly, in certain embodiments, the storage device 200 may be formatted similar to conventional storage devices for formats such as third extended filesystem (EXT3), second extended filesystem (EXT2), File Allocation Table (FAT), New Technology File System (NTFS), and Journaling Flash File System version 2 (JFFS2), and the like.

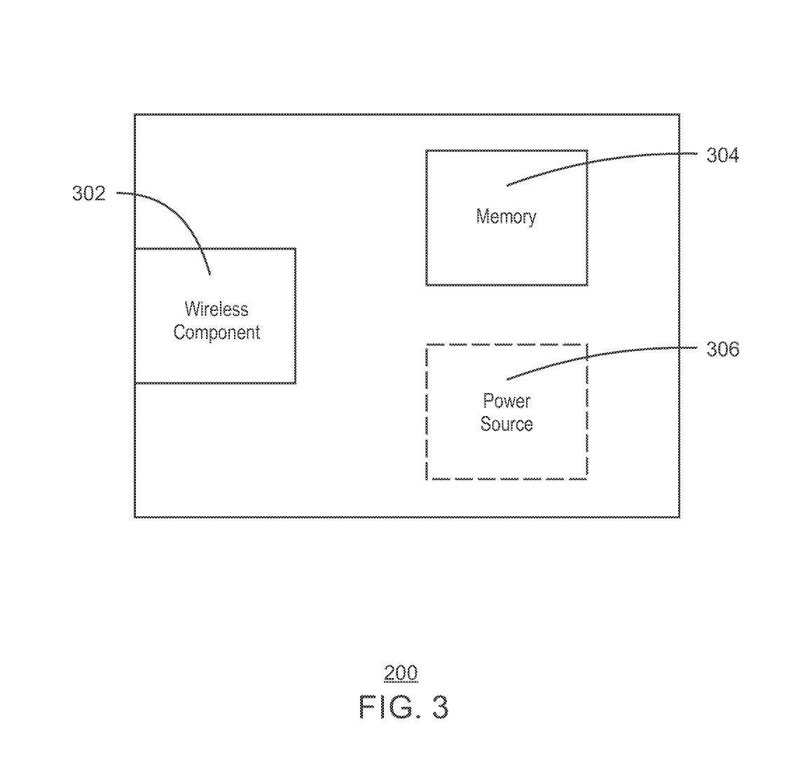

FIG. 3 is a block diagram of exemplary components of an example storage device 200. The illustrated storage device 200 includes a wireless component 302, such as a NFC antenna (inductor) and/or Bluetooth® capability component including a Bluetooth® radio. Indeed, the storage device 200 may be configured for NFC and/or Bluetooth®, or other wireless standard. The touch-based storage device 200 further includes memory 304 which will generally include non-volatile memory such as flash memory and/or other non-volatile memory to provide for storage capacity for the user. In certain examples, portions of the non-volatile memory may store logic instructions or code to facilitate operation of the storage device

For a passive storage device 200 and/or a device 200 not having its own power source, the memory 304 may be primarily or all non-volatile memory. For an active storage device 200 and/or a device 200 having a power source, the memory 304 may include volatile memory. Other memory configurations are applicable. Moreover, as indicated, certain alternative storage devices 200 may optionally have a power source 306, such a battery including a rechargeable battery, and so forth. Furthermore, in alternate embodiments, the storage device may include a memory controller (an integrated circuit, processor, etc.).

In all, the data transfer between the touch-enabled display device 204 (FIG. 2) and the storage device 200 may occur through a wireless medium such as NFC or Bluetooth®, or other similar wireless standard, and the wireless medium capability enabled on both the devices 200 and 204. In certain examples, when the storage device 200 is detected by the electronic device 204, a tag (in the case of NFC) may determine the data action or transfer to be performed. Similarly, if Bluetooth® is employed, the data action or transfer occurs via Bluetooth®. Bluetooth® pairing of the storage device 200 to the electronic device 204 may be beneficial during the first operation between the devices via Bluetooth® (if Bluetooth® is utilized).

As indicated, certain examples of the storage device 200 may include a battery, e.g., to provide power to the wireless component 302, such as if the wireless component 302 is configured with Bluetooth®, for instance. Indeed, the optional battery 306 may be similar to that (e.g., a “nano” battery) employed with Bluetooth® headsets or other conventional Bluetooth® devices. Of course, other types of batteries may be employed. In general, a battery 306 may be beneficial for storage devices 200 that are not NFC capable, or that are not passive.

For a wireless component 302 configured as a NFC component, for instance, the storage device 200 may be a passive device and not require a battery. Indeed, in examples with the touch-based storage device 200 as an NFC device, the device 200 may draw power from the electronic device 204. In particular, the storage device 200 may draw power from the electronic device 204 that reads or writes to storage device 200 due to the magnetic induction associated with NFC or other similar technologies. In fact, for a storage device 200 employing NFC or other passive device techniques, the electronic device 204 may energize the storage device 200 as the storage device 200 becomes proximate or near (or in contract with) the electronic device 204 (e.g., a computing device), facilitating the data transfer between the devices 200 and 204.

A touch-based storage device 200 of the present techniques, upon detection by an electronic device 204, may be configured to be a source storage or destination storage, including in an “on-the-go” fashion. In other words, when the storage device 200 is wirelessly detected by the electronic device 204 and contacts the touchscreen 202 of the electronic device 204, a computation may occur on the electronic device 204 to initiate storage functionalities such as “copy to” and “copy from.” These storage functionalities may be automatically prompted or invoked.

Contents (data) for copy or paste may be based on the X-Y coordinates of the touchscreen display 202 where the storage device 200 contacts the display 202. If relevant data exists on the X-Y coordinate or coordinates where the storage device comes in contact, the data may be copied (or deleted), for example. If no relevant data exists at the X-Y coordinate(s) contacted, a “copy to” of data from the storage device 200 to the electronic device 204 may be invoked, for instance.

The electronic device 204 may generally have an operating system. Further, the electronic device 204 may be configured with a software application that facilitates the electronic device 204 to interact with the storage device 200. To so configure the electronic device 204, such a software application may be downloaded or stored and applied to the electronic device 204, for example. The electronic device 204 may be configured via the software application and software or device driver(s) to facilitate the electronic device to wirelessly detect the storage device 200, manage features related to the storage device 200, recognize the touch contact position of the storage device 200, and to display a menu (e.g., menu 400) in response to contact with the storage device 200, and so forth.

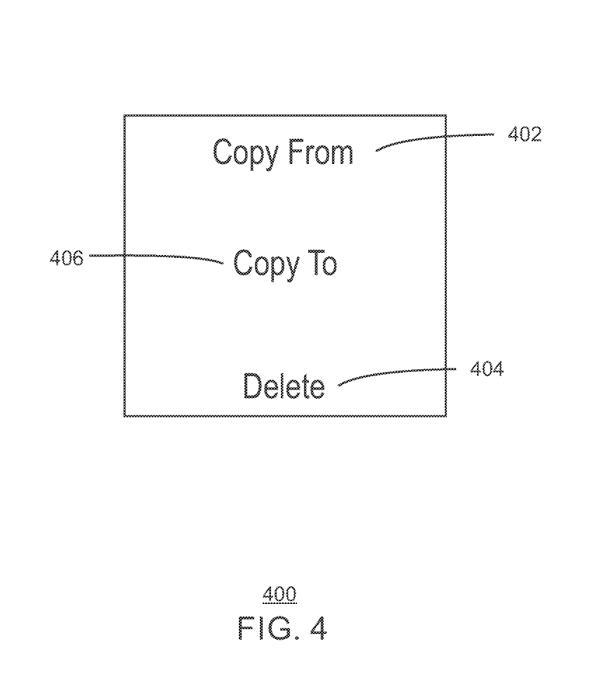

FIG. 4 is an example of a data management menu 400 (e.g., a pop-up menu) that may appear on the touchscreen display 202 of the electronic device 204 when the touch-based storage device 200 is wirelessly detected and comes in contact with the touchscreen display 202. In this example, the user may highlight and select a listed item from the menu 400 via their finger or a stylus, for example. Of course, other input devices for menu 400 item selections may be utilized. Moreover, it should be noted that the menu 400 may be an audible menu in that the electronic device 204 presents the menu 400 items to user audibly, and with the user optionally responding and making selections audibly.

As for the substance of the menu items (i.e., entries or options), if data exists at the X-Y coordinate(s) of the touchscreen 202 location contacted by the storage device 200, the user may be given the option via the menu 400 to “copy from” (as indicated reference numeral 402) the data from the electronic device 204 to the storage device 200. The menu 400 may also optionally give the user the selection to “delete” the data from the electronic device 204, as indicated by reference numeral 404. If no data exists at the particular X-Y coordinates, the “copy from” 402 option (and “delete” option 404) may be grayed or not appear in the menu 400. If no data or no relevant data exists at the X-Y coordinate(s) points(s) or area of contact, the user may be given the option via the menu 400 to “copy to” (as indicated by reference numeral 406), i.e., to copy or move data to the electronic device 204 from the storage device 200. The “copy to” 406 menu 400 option may be grayed or not appear if data or relevant data exists at the X-Y coordinate(s) or within an area defined by the X-Y coordinates. Thus, in embodiments, the storage device 200 may be automatically specified as a destination storage device if relevant data exists or is represented at the X-Y coordinate(s) of contact, and the storage device 200 may be automatically specified as a source storage device if no relevant data exists or is represented at the X-Y coordinate(s) of contact.

The menu 400 operation, the recognition of relevant data at the X-Y coordinate(s) of contact, and the transfer of data may be facilitated by the aforementioned software application and driver(s) on the electronic device 204 and associated with the storage device 200. It should be noted that the techniques described herein including the representations given in FIGS. 1-8 are exemplary systems and methods of which the computing architecture will be understood by one of ordinary skill in the art with the benefit of the present disclosure. As appreciated by the skilled artisan, such architecture may include hardware, and software (logic instructions or code) stored in computer readable media (memory) and executable by the hardware, such as a processor and other structure.

In embodiments, the storage device 200 (and electronic device 204) may be set by the user to automatically transfer data (without an intervening menu 400 appearing) upon contact of the storage device 200 to the touchscreen 202 of the electronic device 204. For example, the storage device 200 may be set to automatically “copy to,” i.e., copy data from the storage device 200 to the electronic device 204, or “copy from,” i.e., copy data from the electronic device 204 to the storage device 200, and so on. In certain embodiments, a user may select such features via the software application installed on the electronic device 204, for instance.

In operation, the electronic device 204 may wirelessly detect the storage device 200 and perform the automatic wireless data transfer upon or in response to contact of the storage device 200 to the touchscreen display 202 of the electronic device 204. In embodiments for data copied from the electronic device 204 to the storage device 200, the data so copied may be data represented on the touchscreen display 202 at a point or area of the contact on the touchscreen display 202 by the storage device 200. Such data copied may be data represented at touch sensor coordinates associated with the touchscreen display 202 at the contact on the touchscreen display 202 by the storage device 200.

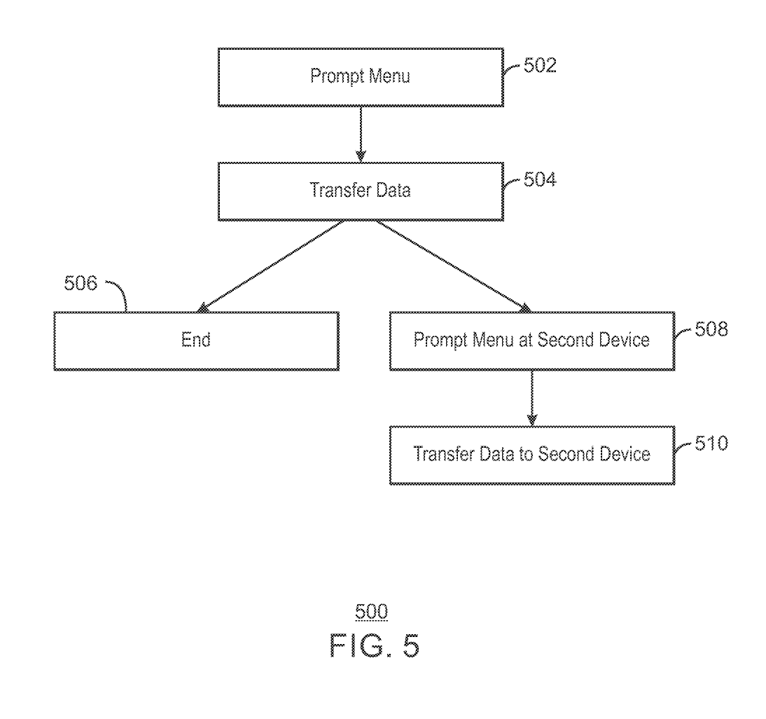

FIG. 5 is an exemplary method 500 of operation of a touch-based storage device, such as the touch-based storage devices 100 and 200 discussed above with respect to FIGS. 1-4 and other touch-based storage devices of the present techniques. The method 500 includes prompting (block 502) a data management menu on a touchscreen display of an electronic device. The prompting may be via a processor and software application of the electronic device upon or in response to wireless recognition of the storage device by the electronic device and contact of the touch-based storage device to the touchscreen display. The electronic device may first wirelessly detect the storage device, as the storage device comes in proximity to the electronic device. In certain embodiments, after such detection, the electronic device may then expect the next touch to its touchscreen display to be the storage device. It should be noted that while the disclosure herein may focus on contact of the storage device to the touchscreen display, the contact may also be via another object or a finger (not the storage device) to the touchscreen display. In other words, after or contemporaneous with the wireless detection of the storage device by the electronic device, the next or contemporaneous touch or contact of the touchscreen display, whether by the storage device or other object (or finger), may prompt a data management menu, and/or indicate the position or location of data representations on the touch screen display, and so forth. Indeed, in response to such contact, whether by the storage device or other object, a data management menu may appear on the touchscreen display of the electronic device. In certain embodiments, the data management menu may be a pop-up menu prompted via the processor and software application (and device driver) to appear on the touchscreen display. Moreover, the data management menu may involve actions related to the transfer of data, deletion of data, and other data management actions.

In certain embodiments, the data management menu includes at least one menu item related to wireless transfer of data between the touch-based storage device and the electronic device (a touch-enabled electronic device). The menu item(s) may include “copy to” and/or “copy from,” for example. In embodiments, “copy to” means to copy data from the touch-based storage device to the electronic device, and “copy from” means to copy data from the electronic device to the touch-based storage device. In alternate embodiments, depending on the intent of the user, the storage device and electronic device may be set by the user to automatically transfer data (without a data management menu appearing) in response to wireless recognition of the storage device by the electronic device and upon contact of the storage device to the touchscreen of the electronic device. In particular alternate examples, the operations of “copy to” or “copy from” may be set to occur automatically, such as with user prior selection via feature options presentable by the software application for the storage device operating on the electronic device.

The method 500 further includes facilitating via the processor the wireless transfer (block 504) of data between the touch-based storage device and the touch-enabled electronic device upon selection of the menu item by a user. The data transferred may include data (e.g., a file) on or represented on the touchscreen display at a point or area of the contact by the storage device on the touchscreen display. For an exemplary “copy from,” the data or representation of the data may initially reside at the points or coordinates of contact on the touchscreen, and the data then copied or moved to the storage device. For an exemplary “copy to,” the data or representation of the data may not initially reside at the points or coordinates of the contact on the touchscreen, but may so reside at that location on the touchscreen after completion of the data transfer from the storage device to the electronic device. In general, the data may be an electronic file, for example, such as a text file or image file, or other types of data. Moreover, the storage device may be characterized as operationally interfacing with the touchscreen display or associated touch sensor because after or contemporaneous with wireless detection, the next touch of the touch screen display may indicate the position of data representation on the touchscreen display (at associated touch sensor coordinates). Such data so represented at that point or area of the touchscreen display (at coordinates of the touchscreen display or the touch sensor) may be copied from the electronic device to the storage device, or data may be copied from the storage device to the electronic device and represented at that touchscreen display location (coordinates) of the contract. Thus, again, in at least this sense, the storage device is configured to operationally interface with the touch screen display and its touch sensor,

In an example of a menu selection or action of a “copy to” where data is transferred from the touch-based storage device to the electronic device, the method 500 may be completed, as indicated by reference numeral 506. Of course, in this case, the storage device may continue to be employed with the electronic device and other touch-enabled electronic devices.

In an example of a menu selection or action of a “copy from” where data is transferred from the electronic device (e.g., data at the point of contact on the touchscreen) to the touch-based storage device, the method may be completed or may continue. Indeed, the method 500 may continue so to provide for transfer of the data to another electronic device, and thus affect a transfer (i.e., remote transfer) of data from the first electronic device to the second electronic device.

Therefore, where data has been copied from the first electronic device to the touch-based storage device, the exemplary method 500 may further include prompting (block 508) via a processor and relevant software application of a second electronic device a data management menu on a touchscreen display of the second electronic device. Such prompting of the menu may occur upon or in response to wireless recognition of the touch-based storage device by the second electronic device and upon or in response to contact of the touch-based storage device to the touchscreen display of the second electronic device. As with the first electronic device, the data management menu appearing on the touchscreen of the second electronic device may involve actions related to the transfer of data, deletion of data, and other data management actions. The data management menu may include at least one menu item related to wireless transfer of data between the touch-based storage device and the second electronic device (a touch-enabled electronic device). A menu item of “copy to,” for example, may be selected to transfer (block 510) data from the touch-based storage device to the second electronic device. Such data copied to the second device may include or be the data copied from the first storage device. Thus, a transfer of such data is effected from the first electronic device to the second electronic device.

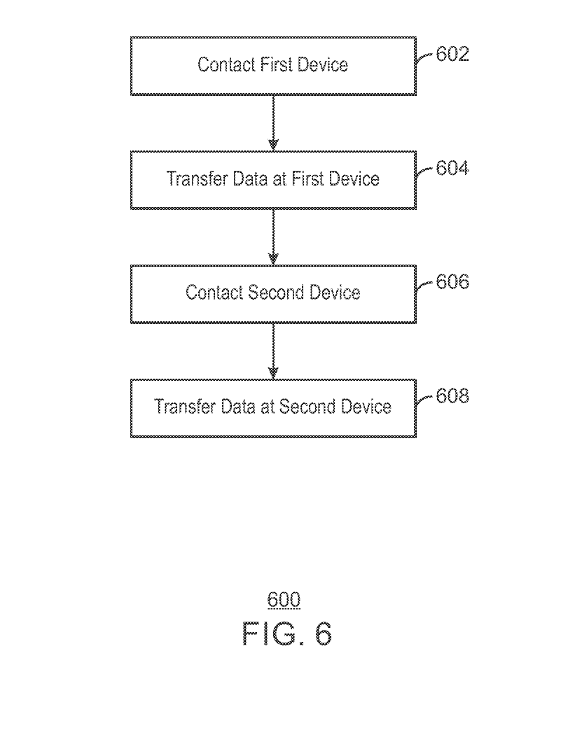

FIG. 6 is an exemplary method 600 of operating a touch-based storage device to implement a transfer of data from a first touch-enabled electronic device to a second touch-enabled electronic device. Initially, the user may contact (block 602) a touchscreen display of the first electronic device with the touch-based storage device. In this example, the touch-based storage device and first electronic device are configured to operationally interface via respective wireless communication components and via a touch sensor associated with the touchscreen display of the first electronic device.

Data may then be transferred (block 604) wirelessly between the first electronic device and the touch-based storage device. Data may be transferred in either direction. Moreover, optionally, the method may conclude with the first electronic device treated as a sole device for the time period of the method.

However, the illustrated method 600 continues so to impart the transfer of the data from the first electronic device to the second electronic device. Thus, in the instant case, as noted, data is initially transferred (block 604) from the first electronic device to the storage device. This data may be at or represented at the points or coordinates of contact on the touchscreen display of the first electronic device.

At a later time and optionally remote from the first electronic device, the user or another user then contacts (block 606) the touch-based storage device to a touchscreen of the second electronic device. As with the first device, the touch-based storage device and the second electronic device are configured to operationally interface via respective wireless communication components and via a touch sensor associated with the touchscreen display of the second electronic device.

Data may then be transferred (block 608) wirelessly between the second electronic device and the touch-based storage device, including a transfer of data from the storage device to the second electronic device. The data so transferred from the touch-based storage device to the second electronic device may include the data initially collected from the first electronic device and stored on the storage device.

Thus, the method 600 provides for data transfer from the first electronic device to the second electronic device via the touch-based storage device. This in contrast to conventional techniques for data transfer between electronic devices which may require (1) relatively close proximity of a wireless connection between the first electronic devices, (2) an intermediate host computer required to transfer data between electronic device, or (3) a USB On-the-Go (OTG) not conducive to many touch-enabled electronic devices, for example.

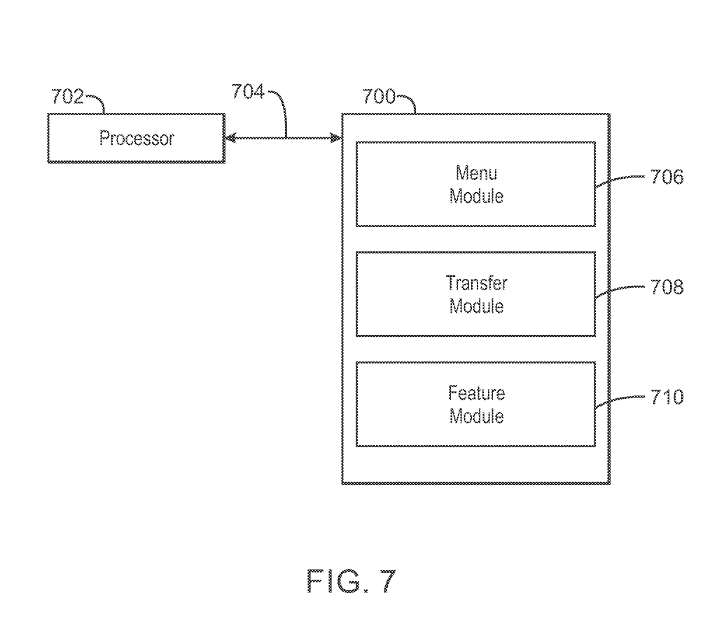

FIG. 7 is a block diagram depicting an example of a tangible, non-transitory computer-readable medium that can facilitate interaction of an electronic device with a touch-based storage device. The tangible, non-transitory, computer-readable medium 700 may be accessed by a processor 702 over a computer interconnect 704. Furthermore, the tangible, non-transitory, computer-readable medium 700 may include code to direct the processor 702 to perform the operations of the techniques described above.

The various software components discussed herein may be stored on the tangible, non-transitory, computer-readable medium 700, as indicated in FIG. 7. For example, a software application may include a menu module 706 which may direct the processor 702 to prompt and display a data management menu. The software application may include a transfer module 708 which may direct the processor 702 to facilitate data transfer in response to a menu item selection, for example, or in response to other actions. The software application may include a feature selection module 710 which may direct the processor to provide a software interface for a user to select desired features, such as features related to the transfer of data with or without the intervening appearance of a menu.

It is to be understood that any number of additional software components not shown in FIG. 7 may be included within the tangible, non-transitory, computer-readable medium 700, depending on the specific application. Further, it should be noted that the processor 702 may be the processor 806 (see FIG, 8) of a touch-enabled electronic device 204, for example. On the other hand, the processor may represent other processors or controllers.

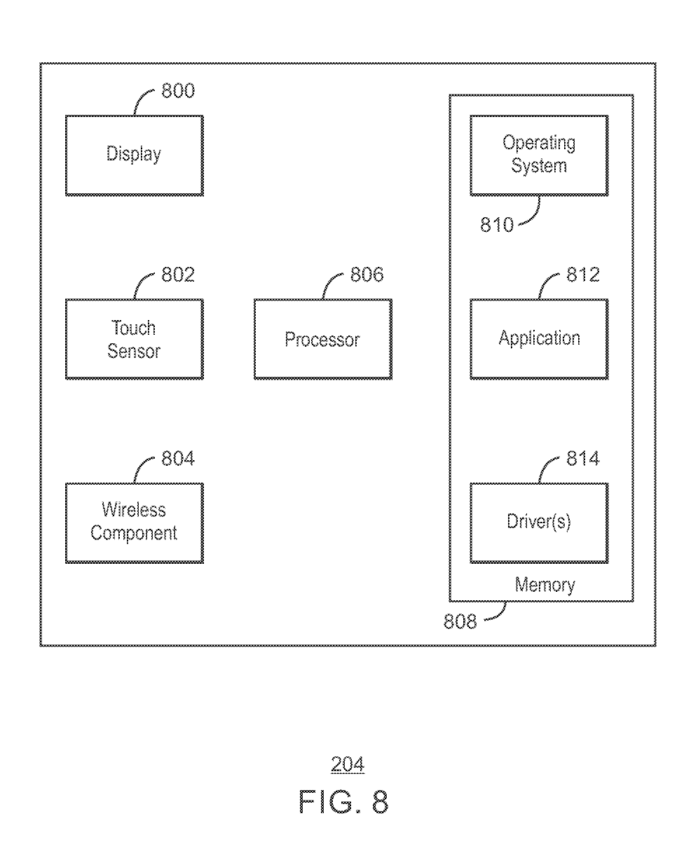

FIG. 8 is an exemplary touch-enabled electronic device 204 (e.g., touch-enabled computing device) configured to interface and operate with a touch-based storage device 200. The electronic device 204 has a touchscreen display 800 (e.g., 202 of FIG. 2) and a touch sensor 802 associated with the display 802. The electronic device 204 may be a computing device, and may be a mobile device and/or handheld device. Examples of the electronic device 204 include a desktop computer, laptop computer, tablet, smartphone, all-in-one (AIO) or portable AIO computing device, and the like.

In the illustrated embodiment, the electronic device 204 has a wireless component 804, such as a NFC antenna (inductor) and/or Bluetooth® capability component including a Bluetooth® radio. Indeed, the electronic device 204 may be configured for NFC and/or Bluetooth®, or other wireless standard. In certain cases of NFC communication with the storage device 200, the electronic device 204 may be the active device in the NFC communication pair.

Further, the electronic device 204 may include a processor 806 and memory 808 storing software code or logic executable by the processor 806. In particular, the code may generally include an operating system 810. Additionally, the code may include an application 812 and device driver(s) 814 that configure the electronic device 204 and operating system 810 to interact with the storage device 200. Such interaction may be with respect to wireless detection and recognition of the storage device 200, as well as wireless communication with the storage device 200 including in the transfer of data and instructing the storage device 200. Also, the operational interaction via the application 812 and driver(s) may include facilitating the prompting and display of a data management menu (e.g., menu 400 of FIG. 4) on the touchscreen display 800 upon or in response to wireless detection and contact of the storage device 200 to the display 800, and so forth.

In certain embodiments, the storage device 200 may have a contact recognition component such that the storage device 200 is recognized by the electronic device 204 based on contact (touch) of the storage device 200 to the touchscreen display of the electronic device 204. Thus, upon contact, the electronic device 204 recognizes that the actual storage device 200 (and not another object or finger) makes the contact with the touchscreen display of the electronic device 204. Examples of the contact recognition component may be a contacting pattern or sensor associated with or on the storage device 200. In particular embodiments, contact recognition may be required for the electronic device 204 to energize the storage device 200 (if passive) and/or to exchange data with the storage device 200. In examples, the contacting pattern may be an induction charge associated with the storage device, or a physical pattern (e.g., points, ridges, tip pattern, raised portion, etc.) on the storage device 200, and so on. The electronic device 204 may be programmed to recognize the contracting pattern and, thus, positively identify the storage device 200 as making contact.

Lastly, certain embodiments may provide communication and data transfer between the storage device 200 and electronic device 204 based on wireless connectivity between the storage device 200 and the electronic device 204 without a touch to the touchscreen of the electronic device 204. Indeed, the wireless connection may effectively provide for such communication and data transfer. However, in combination with the wireless connectivity, data transfer may be also initiated and a location on the electronic device 204 display identified, as the storage device 200, finger, or object, is in a relatively narrow range or short distance from the touchscreen (including without touching the touchscreen). Such initiation of data transfer and recognition of a location on the display or touchscreen may be facilitated through motion detection of a camera on the electronic device 204, IR sensing, capacitive sensing via the capacitive grid for the touchscreen of the electronic device 204, and so forth. With respect to capacitive sensing, the electronic device 204 may detect an increased capacitance as the finger or storage 200 approaches the touchscreen without yet actually touching the touchscreen.

In examples with the storage device 200 wirelessly detected by the electronic device 204, a user with storage device 200 on finger moves the storage device 200 toward the touchscreen at a distance in the ranges of 0.5 inch to 2 inches, 0.5 inch to 4 inches, or 0.5 inch to 6 inches, for instance, to initiate prompting of a menu on the display, recognition of a touchscreen coordinate, data transfer between the storage device 200 and electronic device 204, and so on. In other examples with the storage device wirelessly detected, the user moves a finger or object to within such distances of the touchscreen to initiate prompting of a menu on the display, recognition of a touchscreen coordinate, data transfer, and so forth. In all, with the storage device 200 wirelessly detected or becoming wirelessly detected by the electronic device 204, an initiating element for the features described herein may be the presence of the storage device 200, finger, object, and the like, within ranges of 0.5 inch to 2 inches, 0.5 inch to 4 inches, or 0.5 inch to 6 inches, for instance, from the touchscreen display of the electronic device 204, without having to actually touch the touchscreen.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

### EXAMPLE 1

A touch-based storage device comprises a wireless communication component and a memory. The touch-based storage device is configured to operationally interface with an electronic device via the wireless communication component, and via a touchscreen display and a processor of the electronic device. In particular embodiments, the wireless component may comprise a Near Field Communication (NFC) antenna, a Bluetooth® radio, and so on. In certain embodiments, the touch-based storage device comprises a passive device with respect to power, and wherein the memory comprises non-volatile memory. The touch-based storage device may be configured to operationally contact the touchscreen display of the electronic device, and in response to the contact, configured for wireless transfer of data between the touch-based storage device and the electronic device, and wherein the data comprises data represented at touchscreen display coordinates of the contact.

In embodiments, the touch-based storage device is configured as a destination storage device for transfer of data from the electronic device to the memory of the storage device, and wherein the touch-based storage device is configured as a source storage device for transfer of data from the memory to the electronic device. The touch-based storage device is configured for wireless transfer of data between the touch-based storage device and the electronic device via the wireless communication component. The touch-based storage device may be configured for wireless transfer of data between the touch-based storage device and the electronic device via the wireless communication component and the processor in response to wireless detection of the touch-based storage device by the electronic device and contact of the touchscreen display.

As indicated, the touch-based storage device may be configured to receive data from the electronic storage device in response to the contact of the touchscreen display, and wherein the data comprises data represented at a point of the contact on the touchscreen display. Also, the touch-based storage device may be configured as a data source to the electronic storage device in response to contact of the touchscreen display. In embodiments, the wireless detection of the touch-based storage device by the electronic device and contact of the touchscreen display automatically prompts via the processor a data management menu to appear on the touchscreen display, the data management menu comprising a menu item related to transfer of data between the touch-based storage device and the electronic device. In particular embodiments, the touch-based storage device comprises a thimble-like shape and/or is configured to fit on a finger of a human user.

### EXAMPLE 2

A method of operation of a touch-based storage device comprises wirelessly coupling the touch-based storage device with an electronic device via respective wireless communication components of the touch-based storage device and the electronic device. The method comprises contacting the touchscreen display of the electronic device, wherein the touch-based storage device is configured to operationally interface with a touch sensor associated with the touchscreen display of the electronic device. The method comprises transferring data wirelessly between the storage device and the electronic device, via the wireless coupling and a processor of the electronic device, in response to the wirelessly coupling and the contacting of the touchscreen display.

In embodiments, the data comprises data represented on the touchscreen display at an area or point of the contact on the touchscreen display by the touch-based storage device. In embodiments, the method comprises prompting via the processor a data management menu on the touchscreen display in response to the wireless coupling and the contacting of the touchscreen display, wherein the transferring data wirelessly is in response to selection of a menu item of the data management menu by a user. The method may comprise further transferring the data wirelessly from the touch-based storage device to a second electronic device in response to wireless detection of the touch-based storage device by the second electronic device, combined with contact of a second touchscreen display of the second electronic device.

### EXAMPLE 3

A non-transitory, computer-readable medium comprises a plurality of instructions that, in response to being executed on a processor of an electronic device, cause the electronic device to wirelessly couple with a touch-based storage device in proximity to the electronic device via respective wireless communication components of the touch-based storage device and the electronic device. The executed instructions cause the transfer of data wirelessly between the storage device and the electronic device in response to the wirelessly coupling and to contact of a touchscreen display of the electronic device. The data may comprise data represented at touchscreen display coordinates of the contact. In embodiments, the executed instructions cause the electronic device to prompt a data management menu on the touchscreen display in response to wireless coupling and the contact of the touchscreen display, and wherein the transfer of data wirelessly is in response to selection of a menu item of the data management menu by a user.

### EXAMPLE 4

An electronic device comprises a touchscreen display, a wireless communication component, and a processor. The electronic device comprises a memory storing code executable by the processor to: wirelessly detect via the wireless communication component a touch-based storage device; and wirelessly transfer data with the touch-based storage device via the wireless communication component in response to contact of the touchscreen display. In embodiments, the electronic device comprises a touch sensor associated with the touchscreen display, and wherein the data comprises data represented at touchscreen display coordinates of the contact. The code stored in memory and executable by the processor may configure the electronic device to prompt a data management menu on the touchscreen display in response to the wireless detection of the touch-based storage device and the contact of the touchscreen display. The wireless transfer of data may be initiated by selection of a menu item on the data management menu by a user.

What is claimed is:

1. A touch-based storage device comprising:
a wireless communication component;
a memory; and
wherein the touch-based storage device is configured to operationally interface with an electronic device via the wireless communication component, and via a touchscreen display and a processor of the electronic device.

2. The touch-based storage device of claim 1, wherein the touch-based storage device is configured as a destination storage device for transfer of data from the electronic device to the memory of the storage device, and wherein the touch-based storage device is configured as a source storage device for transfer of data from the memory to the electronic device.

3. The touch-based storage device of claim 1, wherein the touch-based storage device is configured for wireless transfer of data between the touch-based storage device and the electronic device via the wireless communication component.

4. The touch-based storage device of claim 1, wherein the touch-based storage device is configured for wireless transfer of data between the touch-based storage device and the electronic device via the wireless communication component and the processor in response to wireless detection of the touch-based storage device by the electronic device and contact of the touchscreen display.

5. The touch-based storage device of claim 4, wherein the touch-based storage device is configured to receive data from the electronic storage device in response to the contact of the touchscreen display, and wherein the data comprises data represented at a point of the contact on the touchscreen display.

6. The touch-based storage device of claim 1, wherein:
the electronic device is configured detect presence of the touch-based storage device, finger, or object within a range of 0.5 inch to 6 inches from the touchscreen display; and
the touch-based storage device is configured for wireless transfer of data between the touch-based storage device and the electronic device via the wireless communication component and the processor in response to a combination of wireless detection of the touch-based storage device by the electronic device and the presence of the touch-based storage device, finger, or object within the range of 0.5 inch to 6 inches from the touchscreen display.

7. The touch-based storage device of claim 1, wherein the touch-based storage device is configured as a data source to the electronic storage device in response to contact of the touchscreen display.

8. The touch-based storage device of claim 1, wherein wireless detection of the touch-based storage device by the electronic device and contact of the touchscreen display automatically prompts via the processor a data management menu to appear on the touchscreen display, the data management menu comprising a menu item related to transfer of data between the touch-based storage device and the electronic device.

9. The touch-based storage device of claim 1, wherein the touch-based storage device comprises a thimble-like shape.

10. The touch-based storage device of claim 1, wherein the touch-based storage device is configured to fit on a finger of a human user.

11. The touch-based storage device of claim 1, wherein the wireless communication component comprises a Near Field Communication (NFC) antenna.

12. The touch-based storage device of claim 1, wherein the touch-based storage device comprises a passive device with respect to power, and wherein the memory comprises non-volatile memory.

13. The touch-based storage device of claim 1, wherein the wireless communication component comprises a Bluetooth® radio.

14. The touch-based storage device of claim 1, wherein the touch-based storage device is configured to operationally contact the touchscreen display of the electronic device, and in response to the contact, configured for wireless transfer of data between the touch-based storage device and the electronic device, and wherein the data comprises data represented at touchscreen display coordinates of the contact.

15. A method of operation of a touch-based storage device, the method comprising:
wirelessly coupling the touch-based storage device with an electronic device via respective wireless communication components of the touch-based storage device and the electronic device;
contacting the touchscreen display of the electronic device, wherein the touch-based storage device is configured to operationally interface with a touch sensor associated with the touchscreen display of the electronic device; and
transferring data wirelessly between the storage device and the electronic device, via the wireless coupling and a processor of the electronic device, in response to the wirelessly coupling and the contacting of the touchscreen display.

16. The method of claim 15, wherein the data comprises data represented on the touchscreen display at an area or point of the contact on the touchscreen display by the touch-based storage device.

17. The method of claim 15, comprising prompting via the processor a data management menu on the touchscreen display in response to the wireless coupling and the contacting of the touchscreen display, wherein the transferring data wirelessly is in response to selection of a menu item of the data management menu by a user.

18. The method of claim 15, comprising further transferring the data wirelessly from the touch-based storage device to a second electronic device in response to wireless detection of the touch-based storage device by the second electronic device, combined with contact of a second touchscreen display of the second electronic device.

19. A non-transitory, computer-readable medium comprising a plurality of instructions that, in response to being executed on a processor of an electronic device, cause the electronic device to:
wirelessly couple with a touch-based storage device in proximity to the electronic device via respective wireless communication components of the touch-based storage device and the electronic device; and
transfer data wirelessly between the storage device and the electronic device in response to the wirelessly coupling and to contact of a touchscreen display of the electronic device.

20. The non-transitory, computer-readable medium of claim 19, comprising instructions that, in response to being executed on the processor, cause the electronic device to prompt a data management menu on the touchscreen display in response to wireless coupling and the contact of the touchscreen display, and wherein the transfer of data wirelessly is in response to selection of a menu item of the data management menu by a user.

21. The non-transitory, computer-readable medium of claim 19, wherein the data comprises data represented at touchscreen display coordinates of the contact.

22. An electronic device comprising:
a touchscreen display;
a wireless communication component;
a processor; and
a memory storing code executable by the processor to:
wirelessly detect via the wireless communication component a touch-based storage device; and
wirelessly transfer data with the touch-based storage device via the wireless communication component in response to contact of the touchscreen display.

23. The electronic device of claim 22, comprising a touch sensor associated with the touchscreen display, and wherein the data comprises data represented at touchscreen display coordinates of the contact.

24. The electronic device of claim 22, wherein the code stored in memory and executable by the processor configures the electronic device to prompt a data management menu on the touchscreen display in response to the wireless detection of the touch-based storage device and the contact of the touchscreen display.

25. The electronic device of claim 24, wherein the wireless transfer of data is initiated by selection of a menu item on the data management menu by a user.
